(19) United States
(12) Patent Application Publication
(10) Pub. No.: US 2005/0135628 A1
(43) Pub. Date: Jun. 23, 2005

(54) System and method for authenticating components in wireless home entertainment system

(75) Inventor: Behram Dacosta, San Diego, CA (US)

Correspondence Address: ROGITZ & ASSOCIATES, Suite 3120, 750 B Street, San Diego, CA, 92101, US

(73) Assignees: SONY CORPORATION, Tokyo (JP); SONY ELECTRONICS INC., Park Ridge, NJ (US)

(21) Appl. No.: 10/782,345

(22) Filed: Feb. 19, 2004

Related U.S. Application Data
(60) Provisional application No. 60/520,590, filed on Nov. 17, 2003.

(51) Int. Cl. G06F 15/177; H04L 9/00

(52) U.S. Cl. 380/283; 709/221

(57) ABSTRACT

Configuration information is exchanged between a home entertainment system server and various wireless components using a secondary link (such as IR, near field, or removable memory media) that is out-of-band with the primary wireless link of the network, to reduce the chances of an unauthorized device gaining entry to the network. Alternatively, the configuration information can be exchanged over the primary link and the received signal analyzed to determine whether the transmitter of the configuration information is within LOS or otherwise within the home or radius that indicates that it is not likely to be an unauthorized device.

### RELATED APPLICATIONS

This application claims priority from U.S. provisional patent application Ser. No. 60/520,590, filed Nov. 17, 2003.

### BACKGROUND OF THE INVENTION

I. Field of the Invention

The present invention relates generally to home entertainment systems.

II. Background

Wireless home entertainment systems have been provided that can include a set-top box media server that communicates over a wireless system such as an 802.11 system with various components in the home, e.g., TVs, laptop computers, and custom display devices. It is desirable that a rogue device not be permitted on the home network, which would otherwise permit the rogue device to steal content or confidential information on the network and to upload viruses into the network. Also, it is desirable that a component in one home network not mistakenly and non-maliciously gain entry into a neighboring home network.

Accordingly, many wireless home networks require that configuration information (e.g., encryption keys, medium access controller (MAC) addresses) be exchanged between the server and a component seeking admission to the network, prior to providing the component access to the network. The sharing of information ideally is automatically verifiable without user intervention, particularly for consumer electronic devices. Unfortunately, existing systems typically require the user to manually enter information into one or both devices, to ensure that an eavesdropping rogue device outside the home cannot gain admission to the network, and this is not desirable for many devices, e.g., consumer electronic devices. As an alternative, the server and component can be paired at the factory but this results in inflexibility, as the component can be used only with the server with which it is paired. Recognizing these drawbacks, the solutions herein are provided.

### SUMMARY OF THE INVENTION

A home entertainment system includes a wireless system server having a primary communication system. The system also includes at least one wireless component having a primary communication system configured for communicating with the primary communication system of the server. The component sends configuration information to the server using a secondary communication system that is out-of-band with the primary systems. Preferably, the server also sends configuration information using its secondary communication system to the component.

The configuration information can include encryption keys, addresses such as MAC addresses, and identifications such as SSIDs. The primary communication system can be an 802.11 system and the server can be established by a set-top box receiver.

In one implementation, the secondary communication system includes at least one removable media drive and at least one media component removably engageable with the drive. In another implementation, the secondary communication system is an infrared (IR) system, and the server and the component each have a respective IR port. The configuration information is exchangeable through the ports. If desired, the configuration information is exchangeable only when the ports are aligned with each other in line of sight of each other. Or, the system can include a remote control device that establishes a relay node between the ports.

In yet another implementation the secondary communication system is a near field system that requires a communication distance between the component and server of less than about twenty five feet to permit exchange of the configuration information. The configuration information can be exchanged automatically between the server and component when the distance between them is within the communication distance. Or, the configuration information is exchanged between the server and component only when the distance between them is within the communication distance and a user manipulates at least one button on at least one of the server, and the component.

In another aspect, a home entertainment system includes a wireless system server having a primary communication system, and at least one wireless component having a primary communication system configured for communicating with the primary communication system of the server. The component sends configuration information to the server using the primary communication system. The server and/or the component determines a value of a physical parameter of a signal received from the other and affirms proper exchange of information only if the value indicates that the server and component are within an acceptably close distance of each other. As an example, the parameter may be a received signal delay spread or a received distribution of signal strengths, and when the value of the parameter indicates a Rician distribution (indicating a dominant line of sight path between the transmitter and receiver), a valid configuration information exchange is indicated.

In yet another aspect, a method for communication between a home network server and at least one home network component includes, after the successful exchange of configuration information, communicating audio/video information over a wireless link of a primary wireless communication system. The method includes initially exchanging configuration information using a wireless link that is out-of-band with the primary wireless communication system.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIGS. 2-4 are flow charts of various implementations of the logic for authenticating components.

### DETAILED DESCRIPTION OF THE PREFERRED EMBODIMENTS

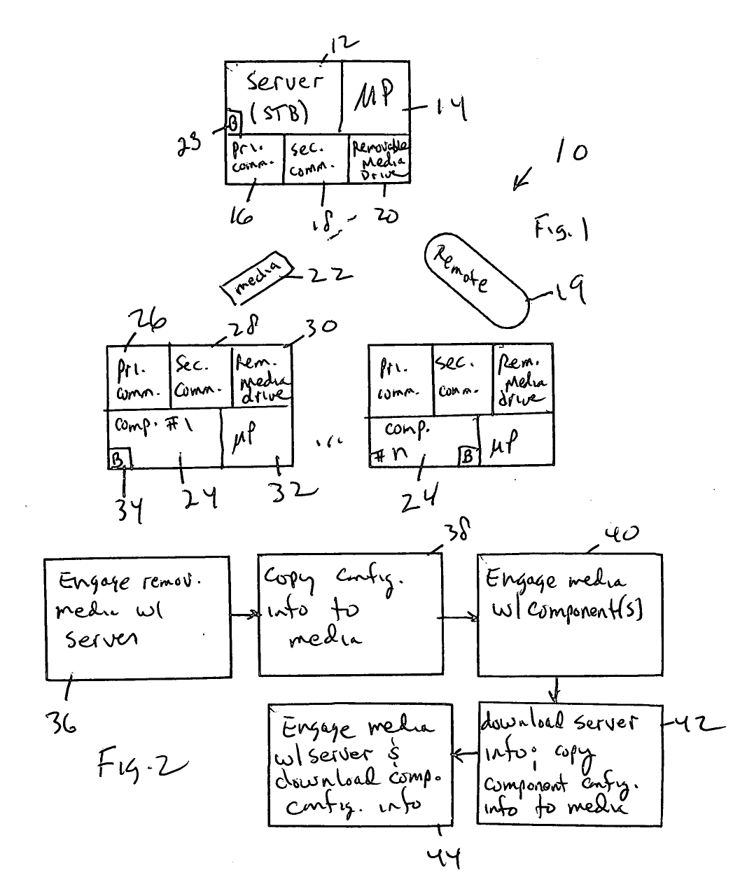

Referring initially to FIG. 1, a home entertainment system is shown, generally designated 10, that includes a server 12 having a processor or processors 14 that may be housed in a set-top box or personal video recorder (PVR) or other component. The server 12 can receive televised content from an antenna, satellite dish, cable, etc. for display of the content on one or more of the below-described system components. The processor 14 alternatively can be incorporated into the housing of a TV to function in accordance with the disclosure herein, or it can be implemented by plural processors (e.g., one in a PVR and one in the TV or set-top box) acting in concert with each other. Or, the server 12 may be implemented by a computer such as a PC or laptop.

In the preferred non-limiting embodiment shown, the processors described herein may access one or more software or hardware elements to undertake the present logic. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

The preferred server 12 shown in FIG. 1 includes a primary wireless communication system 16, such as an 802.11 communication system, and a secondary communication system 18 that is out-of-band with the primary system 16. As set forth further below, the secondary communication system 18 may be a line-of-sight infrared (IR) system, in which case a television or other IR remote control device 19 may be provided. Or, the secondary communication system 18 may be a near-field communication system having an effective range of communication of, e.g., twenty five feet or less. A near-field system may be implemented by a near field “Smart Card”, and may have a frequency of between five and fifteen megaHertz (5 MHz-15 MHz) and use Amplitude Shift Keying (ASK). As understood herein, smart-card like functionality for proximal communication can be incorporated into mobile telephones or other devices. Yet again, the secondary communication system 18 may use personal area network (PAN) principles known in the art to transfer information between the server 12 and the components discussed through a person's body below when the person touches an electrode that is part of each component's secondary communication system. In such an implementation the carrier frequency may be under one megaHertz (<1 MHz), and on-off shift keying may be used for modulation.

In addition, the server 12 can have a removable media drive 20 with which a removable media 22, such as a Sony Memory Stick®, floppy diskette, other flash memory, universal serial bus (USB) dongles, or other removable memory media can be detachably engaged to exchange information between the server 12 and the components discussed below. The drive 20 with media 22 can be considered to be a secondary communication system that is out-of-band with the primary system 16. One or more buttons 23 can also be provided on the server 12 for purposes to be shortly disclosed.

FIG. 1 shows that the system 10 includes one or more wireless components 24, each of which wirelessly communicates with the primary communication system 16 of the server 12 using a respective primary communication system 26. The components 24 may include, e.g., televisions, laptop computers, audio players, projectors, custom display devices, and so on. The primary communication systems are used to communicate, e.g., audio/video data streams from the server 12 to the components 24 for presentation on displays associated with the components 24. Other data may also be transferred over the primary communication systems.

Each component 24 may also include a respective secondary communication system 28 that wirelessly communicates with the secondary communication system 18 of the server 12 in accordance with principles set forth below to exchange configuration information, including, e.g., encryption keys, MAC addresses, SSIDs, and other confidential information that is necessary for authentication and association and that is desired to be kept from an unauthorized device. Also, each component 24 may include a respective removable media drive 30, and be controlled by a respective processor 32. One or more buttons 34 may be provided on each component 24.

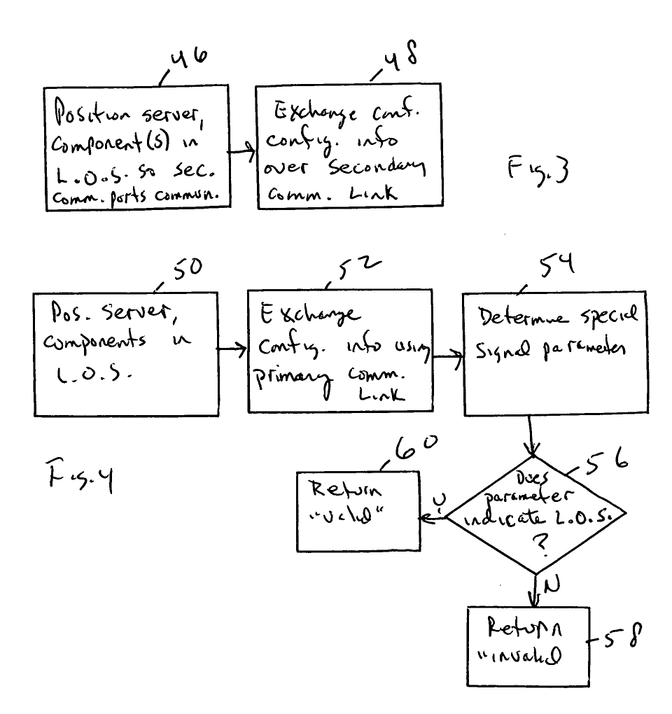

Now referring to FIG. 2, one implementation of the logic for exchanging configuration information between the server 12 and components 24 can be seen. In the embodiment shown in FIG. 2, the removable media 22 is used to exchange the configuration information. Commencing at block 36, the media 22 is engaged with the drive 20 of the server 12, and configuration information of the server 12 is downloaded onto the media 22 at block 38. Then, the media 22 is removed from the server 12 and at block 40 is engaged with the drive 30 of a component 24.

Proceeding to block 42, the configuration information of the server 12 is downloaded from the media 22 to the component 24, and the configuration information of the component 24 is copied onto the media 22. Then, at block 44 the media 22 is removed from the component 24 and reengaged with the drive 20 of the server 12, which downloads the configuration information of the component 24 to complete the configuration information exchange out-of-band with the primary communication systems 16, 26. It is to be understood that the process of FIG. 2 assumes that two-way authentication is required. If only one-way authentication is required, the media 22 is inserted into the component requiring transmission if its configuration information, the configuration information is downloaded onto the media 22, and then the media 22 is inserted into the other component to download the first component's configuration information thereto. Similarly, in a simplified implementation, the media 22 may be sold with the server 12 and already have the configuration information of the server 12 stored therein, so that the above process may commence at block 40 and skip blocks 36 and 38.

The above logic alternatively may be implemented by configuring the removable media 22 as a near field card such as a “Smart Card” and using near field principles known in the art to transfer configuration information using the card.

FIG. 3 shows one implementation of how the secondary communication systems 18, 28 are used to exchange configuration information. If the secondary communication systems are IR systems having respective IR ports such as IR remote control ports that are found on many devices, the logic of FIG. 3 commences at block 46, wherein the server 12 and component 24 are positioned in line of sight (LOS) of each other, with their IR ports aligned with each other as necessary to achieve communication therebetween. At block 48, the necessary configuration information is transferred between the devices over the secondary communication systems 18, 28. Alternatively, the remote control device 19 can be used as a mobile relay node with storage between the server 12 and component 24 if LOS and/or IR port alignment is not feasible.

In an alternate embodiment the secondary communication system may be a near-field communication system in accordance with principles discussed above. A non-limiting example of a near field communication system is disclosed in U.S. Pat. No. 6,121,933, incorporated herein by reference. In such an embodiment the step at block 46 is accomplished by moving the server 12 and component 24 close together, to within the communication distance of the secondary system. The configuration information is automatically exchanged at block 48 once the server 12/component 24 detect the other within its near field. Or, instead of automatic exchange, to initiate transfer of configuration information the user may be required to depress one or both of the buttons 23 (server) or 34 (component).

As yet another alternative, the near field system can be implemented by using the body of the person as the link between components. U.S. Pat. No 5,796,827, incorporated herein by reference, discloses one such system. More specifically, the person might be required to simultaneously touch both buttons 23, 34 (which can be, e.g., personal area network (PAN) electrodes) to complete the secondary communication system path between the server 12 and component 24. As is known in the PAN art, the signal path is through the user's body and the return path is through the near electromagnetic field. While the field may be intercepted by nearby components 24 that are not touched, the electrodes that are touched can indicate which devices are to communicate configuration information with each other.

FIG. 4 shows yet another way to transfer configuration information between the server 12 and component 24. Commencing at block 50, the server 12 and component 24 are positioned within LOS of each other. At block 52 configuration information is exchanged over the primary communication systems but not yet validated. Proceeding to block 54, one or both of the server 12 and component 24 determine a value of a special physical parameter of its received signal. This parameter may be a delay spread and/or distribution of signal strengths over receiver antennae. In the case of a received signal spread/distribution, it can be determined at decision diamond 56 whether the spread/distribution has a Rician distribution throughout configuration information transfer and/or whether the signal strengths over the various antennae of each receiving device match legacy distribution/signal strength information for various LOS angles. This information can be obtained from the RF signal prior to equalization.

As understood herein, a Rician distribution indicates RF transmission with a dominant LOS component (and, hence, transmission from a legitimate component 24). Accordingly, at decision diamond 56 it is essentially determined whether the value of the parameter indicates LOS or other outcome that represents the presence of a legitimate device. If not, “invalid configuration information exchange” is returned at block 58 and the component 24 is denied entry to the home network. On the other hand, if the test at decision diamond 56 is passed, “valid configuration information exchange” is returned at block 60, and the component 24 is admitted to the network. In a minor variation, the configuration information is exchanged only if the parameter indicates a Rician distribution for received RF signals.

Preferably, the allowed delay spread accounts for known scattering in the vicinity of the receiving device. To further promote system integrity, the user may be required to manipulate a button on either or both devices synchronously with configuration information transfer.

While the particular SYSTEM AND METHOD FOR AUTHENTICATING COMPONENTS IN WIRELESS HOME ENTERTAINMENT SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We claim:

1. A home entertainment system, comprising:
at least one wireless system server having at least a primary communication system; and
at least one wireless component having at least a primary communication system configured for communicating with the primary communication system of the server, wherein the component sends configuration information to the server using a secondary communication system that is out-of-band with the primary systems.

2. The system of claim 1, wherein the server sends configuration information using a secondary communication system to the component.

3. The system of claim 1, wherein the configuration information includes at least one of: an encryption key, an address, and an identification.

4. The system of claim 1, wherein the secondary communication system includes at least one removable media drive and at least one media component removably engageable with the drive.

5. The system of claim 1, wherein the secondary communication system is an infrared (IR) system, each of the server and the component having at least one respective IR port, the configuration information being exchangeable through the ports.

6. The system of claim 5, wherein the configuration information is exchangeable only when the ports are aligned with each other in line of sight of each other.

7. The system of claim 5, further comprising a remote control device establishing a relay node between the ports.

8. The system of claim 1, wherein the secondary communication system is a near field system that requires a communication distance between the component and server of less than about twenty five feet to permit exchange of the configuration information.

9. The system of claim 8, wherein the configuration information is exchanged automatically between the server and component when the distance between them is within the communication distance.

10. The system of claim 8, wherein the configuration information is exchanged between the server and component only when the distance between them is within the communication distance and a user manipulates at least one button on at least one of the server, and the component.

11. The system of claim 1, wherein the secondary communication systems are personal area networks (PAN).

12. The system of claim 1, wherein the primary communication system is an 802.11 system.

13. The system of claim 12, wherein the server is established by a set-top box receiver.

14. A home entertainment system, comprising:
at least one wireless system server having at least a primary communication system; and
at least one wireless component having at least a primary communication system configured for communicating with the primary communication system of the server, wherein the component sends configuration information to the server using the primary communication system, at least one of: the server, and the component, determining a value of at least one physical parameter of a signal received from the other and affirming proper exchange of information only if the value indicates that the server and component are within an acceptably close distance of each other.

15. The system of claim 14, wherein the parameter is at least one of: a received signal delay spread, and a received distribution of signal strengths.

16. The system of claim 15, wherein when the value indicates a Rician distribution, a valid configuration information exchange is indicated.

17. The system of claim 14, wherein to effect the exchange of confidential information, a user must manipulate a button on either or both the server and component synchronously with configuration information transfer.

18. A method for communication between a home network server and at least one home network component, comprising:
after the successful exchange of configuration information, communicating audio/video information over a wireless link of a primary wireless communication system; and
exchanging configuration information using a wireless link that is out-of-band with the primary wireless communication system.

19. The method of claim 18, wherein the configuration information includes at least one of: an encryption key, an address, and an identification.

21. The method of claim 18, wherein the secondary communication system includes at least one removable media drive and at least one media component removably engageable with the drive.

22. The method of claim 18, wherein the secondary communication system is an infrared (IR) system, each of the server and the component having at least one respective IR port, the configuration information being exchanged through the ports.

23. The method of claim 22, comprising exchanging the configuration information only when the ports are aligned with each other in line of sight of each other.

24. The method of claim 22, further comprising establishing a relay node between the ports using a remote control device.

25. The method of claim 18, wherein the secondary communication system is a near field system that requires a communication distance between the component and server of less than about twenty five feet to permit exchange of the configuration information.

26. The method of claim 25, comprising automatically exchanging the configuration information between the server and component when the distance between them is within the communication distance.

27. The method of claim 25, comprising exchanging configuration information between the server and component only when the distance between them is within the communication distance and a user manipulates at least one button on at least one of the server, and the component.

28. The method of claim 18,. wherein the secondary communication systems are personal area networks (PAN).

29. The method of claim 18, wherein the primary communication system is an 802.11 system.

30. The method of claim 18, wherein the server is established by a set-top box receiver.
